(19) United States
(12) Patent Application Publication
(10) Pub. No.: US 2015/0058803 A1
(43) Pub. Date: Feb. 26, 2015

(54) METHOD AND APPARATUS FOR FACILITATING CONTROL OF A PRESENTATION

(71) Applicant: HERE GLOBAL B.V., LB Veldhoven (NL)

(72) Inventor: Sreejumon Kundilepurayil, Cupertino, CA (US)

(73) Assignee: HERE GLOBAL B.V., LB Veldhoven (NL)

(21) Appl. No.: 13/974,803

(22) Filed: Aug. 23, 2013

(51) Int. Cl. G06F 3/0481; H04L 29/06; G06F 3/0482; G06F 17/30

(52) U.S. Cl. CPC G06F 3/04817; G06F 17/30879; H04L 63/08; G06F 3/0482
USPC 715/810; 235/375; 726/4

(57) ABSTRACT

Various methods are provided for facilitating control of a presentation using a mobile terminal or other computing device. One example method may comprise causing authorized establishment of a session by scanning a code related to the session, causing an allowance of an input of at least one of a selection of data content and one or more commands, receiving the input of at least one of the content selection and the one or more commands, and causing transmission of the input to a network destination.

### TECHNOLOGICAL FIELD

Embodiments of the present invention relate generally to a method, apparatus, and computer program product for facilitating control of a screen presentation using a smart phone.

### BACKGROUND

Wireless communication is becoming more widespread as a continually increasing number of users acquire and place into operation ever-greater numbers of mobile communication devices. As such, more applications are being developed for such devices as the number of devices grows. For example, someone delivering a session/presentation over a big screen may have a mobile communication device, such as smart phone, but may be unable to control and/or interact with the session/presentation via the mobile communication device. Currently, methods for utilizing existing smart phones and the widespread access to wireless communication do not exist for allowing the presenter to give the presentation while walking around the stage or among the audience, and if wanted, writing/drawing on the presentation utilizing the mobile communication device as the interface via which to write or draw. Additionally, if anyone from the audience wants to write/draw anything on the screen, there are no solutions available for utilizing their existing smart phone and wireless access to provide such input.

### BRIEF SUMMARY

A method, apparatus and computer program product are therefore provided according to an example embodiment of the present invention for facilitating control of a screen presentation using a smart phone.

In one embodiment, a method may be provided, the method comprising causing, with a processor, authorized establishment of a session, causing an allowance of an input of at least one of a selection of data content or one or more commands, receiving the input of at least one of the content selection or the one or more commands, and causing transmission of the input to a network destination. In one embodiment, the method may further comprise, subsequent to the establishment of the session, causing display of one or more text or icons representative of data content for selection. In one embodiment, the method may further comprise, subsequent to a reception of an input of data content selection and transmission of the input of the content selection, causing display of the data content on a display of a user device.

In one embodiment, the method may further comprise, subsequent to a reception of an input of data content selection and transmission of the input of the content selection, receiving an input command related to the content. In one embodiment, the command is at least one of a changing of a screen view, pointer navigation, highlighting, writing, adding of one or more icons, clearing or saving. In one embodiment, causing authorized establishment of a session is performed by scanning a code related to the session.

In another embodiment, a method may be provided, the method comprising generating a code allowing authorized establishment of a session between a mobile terminal and a computing device when the code is displayed by computing device and read by mobile terminal, receiving at least one of a selection of data content and one or more commands, and causing transmission, in an instance of a selection of data content, of the data content related to the selection, or causing transmission, in an instance of a selection of a command, of the command to the computing device. In one embodiment, the method may further comprise, causing transmission of data representative of one or more data content available to the mobile terminal for selection, receiving a selection from the mobile terminal, and causing transmission of data content related to the selection to the computing device.

In one embodiment, the method may further comprise, subsequent to transmitting the data content related to the selection to the mobile terminal, receiving an input command. In one embodiment, the command is at least one of at least one of a changing of a screen view, pointer navigation, highlighting, writing, adding of one or more icons, clearing, or saving. In one embodiment, allowing authorized establishment of a session between a mobile terminal and a computing device when the code is displayed by a computing device, read by a mobile terminal, and provided to a network device.

In another embodiment, an apparatus may be provided, the apparatus comprising a processor and a memory having computer code stored therein, the computer code configured, when executed by the processor, to cause the apparatus to cause, with a processor, authorized establishment of a session, cause an allowance of an input of at least one of a selection of data content or one or more commands, receive the input of at least one of the content selection or the one or more commands, and cause transmission of the input to a network destination. In one embodiment, the computer code is further configured, when executed by the processor, to cause the apparatus to subsequent to the establishment of the session, cause display of one or more text or icons representative of data content for selection.

In one embodiment, the computer code is further configured, when executed by the processor, to cause the apparatus to subsequent to a reception of an input of data content selection and transmission of the input of the content selection, cause display of the data content on a display of a user device. In one embodiment, the computer code is further configured, when executed by the processor, to cause the apparatus to subsequent to a reception of an input of data content selection and transmission of the input of the content selection, receive an input command related to the content. In one embodiment, the command is at least one of a changing of a screen view, pointer navigation, highlighting, writing, adding of one or more icons, clearing or saving. In one embodiment, causing authorized establishment of a session is performed by scanning a code related to the session.

In another embodiment, an apparatus may be provided, the apparatus comprising a processor and a memory having computer code stored therein, the computer code configured, when executed by the processor, to cause the apparatus to generate a code allowing authorized establishment of a session between a mobile terminal and a computing device when the code is displayed by computing device and read by mobile terminal, receive at least one of a selection of data content and one or more commands, and cause transmission, in an instance of a selection of data content, of the data content related to the selection, or cause transmission, in an instance of a selection of a command, of the command to the computing device. In one embodiment, the computer code is further configured, when executed by the processor, to cause the apparatus to cause transmission of data representative of one or more data content available to the mobile terminal for selection, receive a selection from the mobile terminal, and cause transmission of data content related to the selection to the computing device.

In one embodiment, the computer code is further configured, when executed by the processor, to cause the apparatus to subsequent to transmitting the data content related to the selection to the mobile terminal, receive an input command. In one embodiment, the command is at least one of at least one of a changing of a screen view, pointer navigation, highlighting, writing, adding of one or more icons, clearing, or saving. In one embodiment, the computer code is further configured, when executed by the processor, to cause the apparatus to allow authorized establishment of a session between a mobile terminal and a computing device when the code is displayed by a computing device, read by a mobile terminal, and provided to a network device.

In one embodiment, a computer program product may be provided, the computer program product comprising at least one computer-readable storage medium having computer-executable program code instructions stored therein, the computer-executable program code instructions comprising program code instructions for causing authorized establishment of a session, causing an allowance of an input of at least one of a selection of data content or one or more commands, receiving the input of at least one of the content selection or the one or more commands, and causing transmission of the input to a network destination. In one embodiment, the computer-executable program code portions further comprise program code instructions for, subsequent to the establishment of the session, causing display of one or more text or icons representative of data content for selection. In one embodiment, the computer-executable program code portions further comprise program code instructions for, subsequent to a reception of an input of data content selection and transmission of the input of the content selection, causing display of the data content on a display of a user device.

In one embodiment, the computer-executable program code portions further comprise program code instructions for, subsequent to a reception of an input of data content selection and transmission of the input of the content selection, receiving an input command related to the content. In one embodiment, the command is at least one of a changing of a screen view, pointer navigation, highlighting, writing, adding of one or more icons, clearing or saving. In one embodiment, causing authorized establishment of a session is performed by scanning a code related to the session.

In one embodiment, a computer program product may be provided, the computer program product comprising at least one computer-readable storage medium having computer-executable program code instructions stored therein, the computer-executable program code instructions comprising program code instructions for generating a code allowing authorized establishment of a session between a mobile terminal and a computing device when the code is displayed by computing device and read by mobile terminal, receiving at least one of a selection of data content and one or more commands, and causing transmission, in an instance of a selection of data content, of the data content related to the selection, or causing transmission, in an instance of a selection of a command, of the command to the computing device. In one embodiment, the computer-executable program code portions further comprise program code instructions for, causing transmission of data representative of one or more data content available to the mobile terminal for selection, receiving a selection from the mobile terminal, and causing transmission of data content related to the selection to the computing device.

In one embodiment, the computer-executable program code portions further comprise program code instructions for, subsequent to transmitting the data content related to the selection to the mobile terminal, receiving an input command. In one embodiment, the command is at least one of at least one of a changing of a screen view, pointer navigation, highlighting, writing, adding of one or more icons, clearing, or saving. In one embodiment, allowing authorized establishment of a session between a mobile terminal and a computing device when the code is displayed by a computing device, read by a mobile terminal, and provided to a network device.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is an example flowchart illustrating a method of operating an example apparatus in accordance with an embodiment of the present invention.

FIG. 4 is an example flowchart illustrating a method of operating an example apparatus in accordance with an embodiment of the present invention;

FIG. 5 is an example flowchart illustrating a method of operating an example apparatus in accordance with an embodiment of the present invention;

FIG. 6 is a block diagram of a single user device system that may be specifically configured in accordance with an example embodiment of the present invention; and

FIG. 7 is a block diagram of a multiple user device system that may be specifically configured in accordance with an example embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

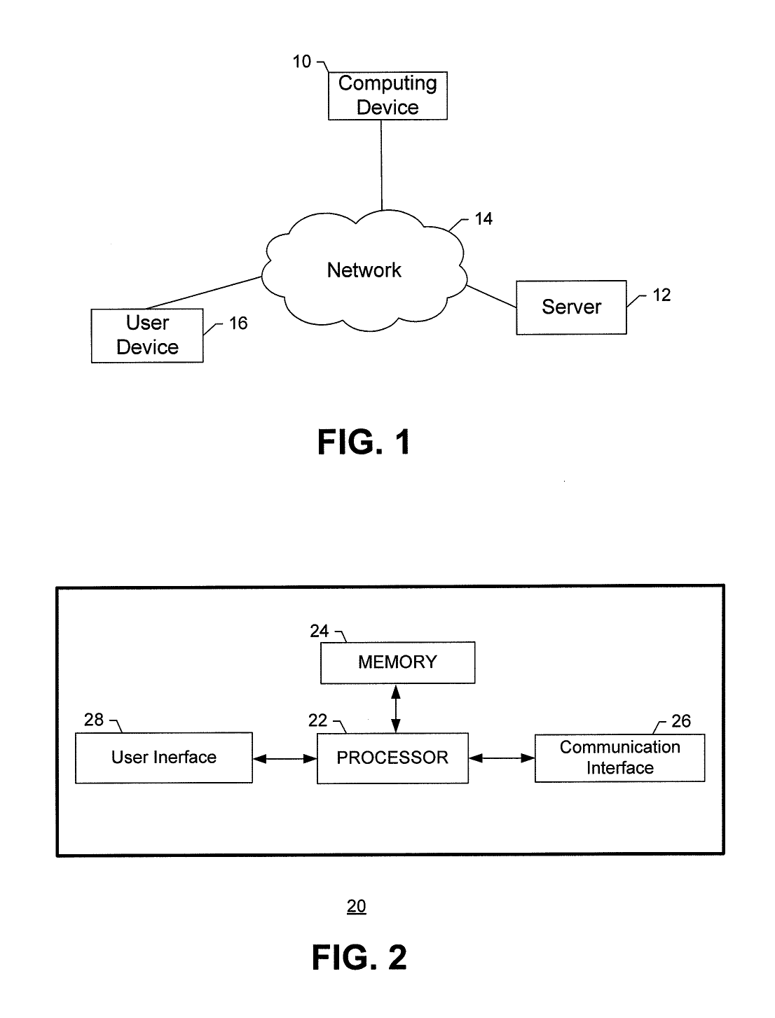

Referring now of FIG. 1, a system that supports communication, either wirelessly or via a wireline, between a computing device 10 and a server 12 or other network entity (hereinafter generically referenced as a “server”) is illustrated. As shown, the computing device and the server may be in communication via a network 14, such as a wide area network, such as a cellular network or the Internet, or a local area network. However, the computing device and the server may be in communication in other manners, such as via direct communications between the computing device and the server. The user device 16 will be hereinafter described as a mobile terminal, but may be either mobile or fixed in the various embodiments

The computing device 10 and user device 16 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

In an example embodiment of the present invention, a user may utilize a system, including a computing device, such as a laptop, and a screen, e.g., a big screen, connected to the computing device, to display a presentation. In order to walk around the room while writing or drawing upon the presentation that is displayed, the user may utilize a mobile terminal, such as their smart phone, to transmit instructions or commands that control or otherwise permit interaction with presentation, such as by permitting the presenter and/or audience members to write or draw upon the presentation that is displayed. In some embodiments, a user may utilize a laptop or other computing device, configured with wireless access to a network, to access a particular network address, such as a uniform resource locator (URL). After, optionally, a log in process, the laptop may display a code, such as a quick response (QR) code. The code may be scanned by a mobile terminal, such as the user's smart phone, in order to establish a session with the laptop, which would allow access to the presentation to be displayed on the laptop, by the smart phone.

Once the session is established, the user may be able to select one of one or more presentations to be displayed via the mobile terminal. The presentation may then be transmitted to the laptop and/or displayed on the big screen. While the presentation is being given, the user may input instructions or commands into the mobile terminal, such as into a browser or web app installed on the mobile terminal. In some embodiments, the instructions or commands are then sent to the browser installed or otherwise running on the computing device, by for example web sockets. In one embodiment, drawing or text instructions may be displayed in an overlaid manner on top of a HTML5 canvas on the computing device.

The user may provide a variety of instructions to control the presentation via their mobile terminal. In this regard, some example instructions or commands are loading a presentation and changing the slides of the presentation that is being displayed, showing and/or navigating using a pointer, highlighting one or more sections of presentations being displayed, writing and/or drawing on the displayed presentation, adding particular or special icons (e.g., smiley, tick marks) on the screen, clearing the screen, saving an updated screen. Each of the previous operations may be instructed from the mobile terminal, and attendees see the product of those instructions that have been provided to the laptop or other computing device reflected upon the screen. A user does not have to install anything on the laptop or other computing device and instead may just use the browser to access the predefined network address, such as by opening the dedicated url.

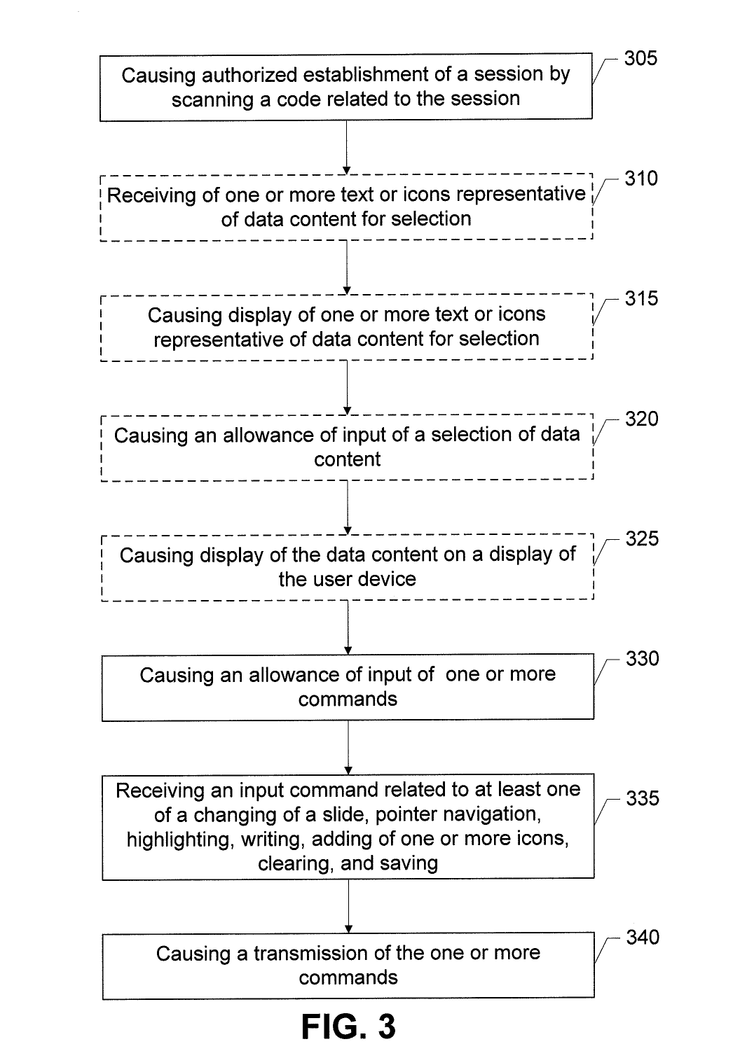

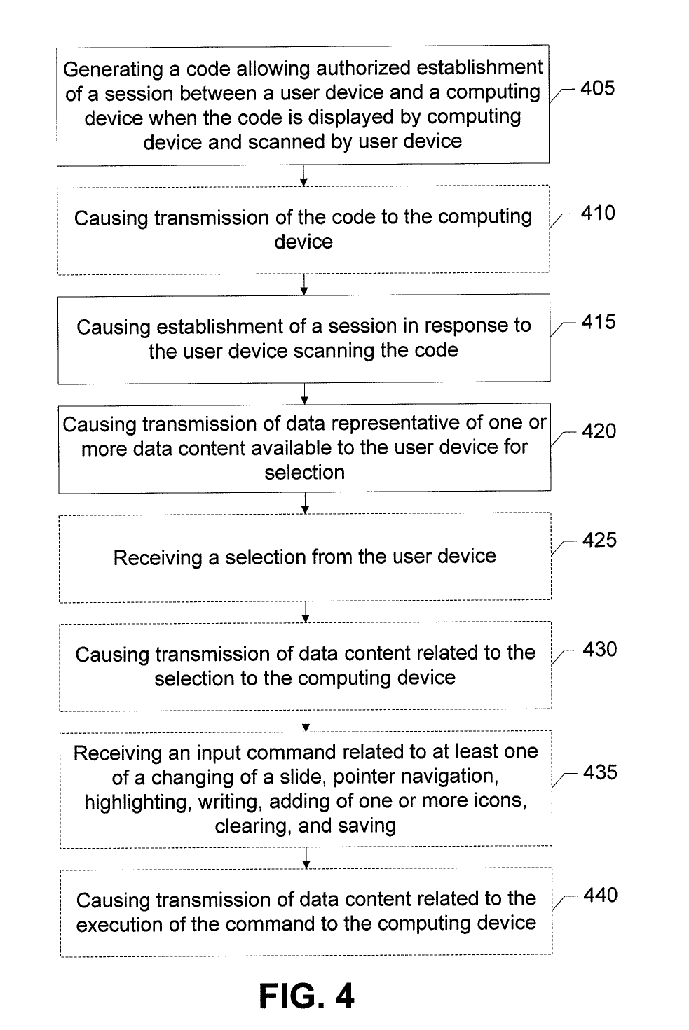

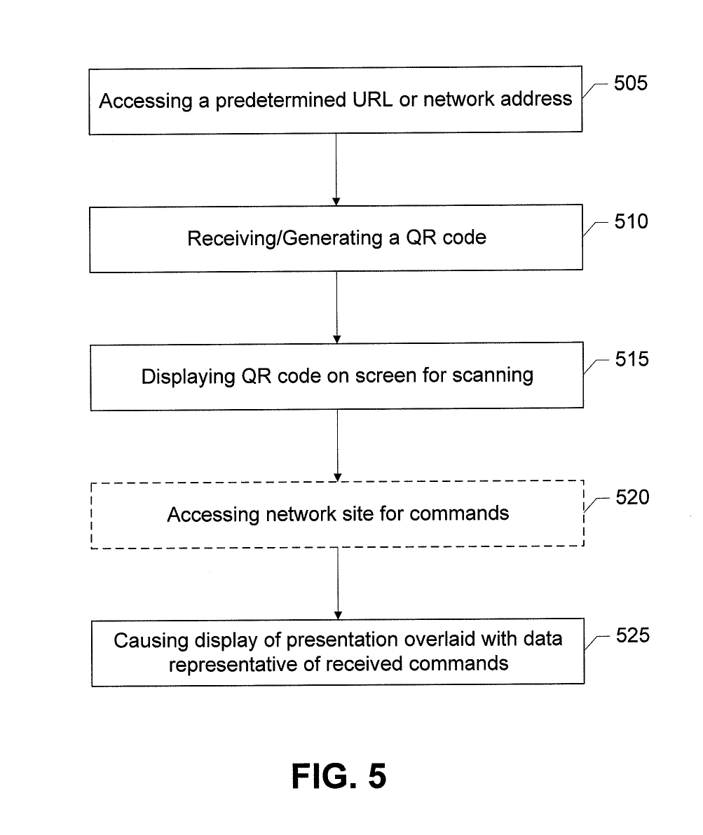

FIGS. 3, 4, and 5 illustrate example flowcharts of the example operations performed by a method, apparatus and computer program product in accordance with an embodiment of the present invention. FIG. 3 is shown from the perspective of the user device, FIG. 4 from the perspective of the server, and FIG. 5 from the perspective of the computing device. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3, 4, and 5, when executed, convert a computer or processing circuitry into a particular machine configured to perform an example embodiment of the present invention. Accordingly, the operations of FIGS. 3, 4, and 5 define an algorithm for configuring a computer or processing to perform an example embodiment. In some cases, a general purpose computer may be provided with an instance of the processor which performs the algorithms of FIGS. 3, 4, and 5 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included as shown by the blocks having a dashed outline in FIGS. 3, 4 and 5. It should be appreciated that each of the modifications, optional additions or amplifications below may be included with the operations above either alone or in combination with any others among the features described herein.

In some example embodiments, a method, apparatus and computer program product may be configured for facilitating control of a screen presentation using a user device such as a smart phone, cellular phone, tablet, laptop or any type of mobile terminal. In one embodiment of the present invention, a user device may control operation of displayed content on a second device through use an application, website or the like.

FIG. 3 is an example flowchart illustrating a method for controlling data content, such as a presentation, using a user device in accordance with an embodiment of the present invention. The presentation being displayed by or on a computing device. For example, the presentation may be displayed on or by a computing device, and may be displayed on a display of the computing device or another screen upon which presentation is projected. In one embodiment, the method may enable a mobile terminal to control a presentation being displayed on a laptop and/or connected projector screen. It should be appreciated that the operations of FIG. 3, though performed by a smart phone in some embodiments, are not limited to cellular systems. For example, non-cellular solutions such as a wireless local area network (WLAN), may similarly permit the control of data content being displayed on a computing device, such a laptop, using a user device, such as a smart phone.

As shown in block 305 of FIG. 3, an apparatus, such as apparatus 20 embodied by the user device 16, may be configured to cause an authorized establishment of a session by scanning a code related to the session. The apparatus embodied by user device 16 therefore includes means, such as the processor 22, the communication interface 26 or the like, for causing authorized establishment of a session by reading (e.g., scanning) a code related to the session. Although the user device may scan any of a wide variety of codes, the code of one embodiment may be a quick response (QR) code being displayed on a screen of a laptop or the like. The user device may be configured with an application for scanning QR codes. In some embodiments, one or more of the steps in the method illustrated by FIG. 3 utilize a web application (“app”) installed on the user device.

As shown in block 310 of FIG. 3, the apparatus 20 embodied by the user device 16 may also be configured to receive indications of one or more text or icons representative of data content for selection. The apparatus embodied by the user device 16 therefore includes means, such as the processor 22, the communication interface 26 or the like, for receiving indications of one or more text or icons representative of data content for selection. For example, the user device may receive data indicative of a list of available presentations. The presentations may be listed by title. In some embodiments, the user device may receive one or more icons representative of each of one or more presentations, data content or the like. As shown in block 315 of FIG. 3, the apparatus 20 embodied by the user device 16 may also be configured to cause display of one or more text or icons representative of data content for selection. The apparatus embodied by the user device 16 therefore includes means, such as the processor 22, the communication interface 26 or the like, for causing display of one or more text or icons representative of data content for selection.

As shown in block 320 of FIG. 3, the apparatus 20 embodied by the user device 16 may further be configured to cause an allowance of input of a selection of data content. The apparatus embodied by the user device 16 therefore includes means, such as the processor 22, the communication interface 26 or the like, for causing an allowance of input of a selection of data content. For example, the apparatus may be programmed to recognize different types of input to be selections of respective data content. In some embodiments, the user may touch a display screen of the user device, for example with their finger, a stylus or the like. In other embodiments, a user may push a button or key associated with a particular selection.

In some embodiments, as shown in block 325 of FIG. 3, the apparatus 20 embodied by the user device 16 may be configured to cause display of the data content on a display of the user device. The apparatus embodied by the user device 16 therefore includes means, such as the processor 22, the communication interface 26 or the like, for causing display of the data content on a display of the user device. For example, the user device or an application executed by the user device may be configured to cause the user device to display the presentation. In some embodiments, a presentation, on another screen, such as a large screen associated with a laptop or other computing device with which the mobile terminal is in communication and upon which the data content is projected. In some embodiments, the display of the user device may show a different view of the data content, for example, a different slide, a different format (e.g., text only), a different portion (e.g., a zoomed view), or a view with notes not displayed on the big screen. In some embodiments, the user device may be configured to communicate directly with a projector to display the data content upon a screen.

As shown in block 330 of FIG. 3, the apparatus 20 embodied by the user device 16 may be configured to cause an allowance of input of one or more commands. The apparatus embodied by the user device 16 of this embodiment therefore includes means, such as the processor 22, the communication interface 26 or the like, for causing an allowance of input of one or more commands. For example, the apparatus may be programmed to recognize different types of input to be selections of respective data content. As shown in block 335 of FIG. 3, the apparatus 20 embodied by the user device 16 may also be configured to receiving an input command or instruction. The apparatus embodied by the user device 16 of this embodiment therefore includes means, such as the processor 22, the communication interface 26 or the like, for receiving an input command or instruction. For example, commands or instructions may be related to at least one of a changing of a slide, pointer navigation, highlighting, writing on the screen or in the presentation, adding of one or more icons, clearing the screen, and saving the screen, or the like. For example, the apparatus may be configured such that one or more commands or instructions cause a representation of input provided by the user to be displayed or overlaid upon the display upon the screen.

As shown in block 340 of FIG. 3, the apparatus 20 embodied by the user device 16 may be configured to cause transmission of the one or more commands to a network destination. The apparatus embodied by the user device 16 of this embodiment therefore includes means, such as the processor 22, the communication interface 26 or the like, for causing transmission of the one or more commands to a network destination. The one or more commands may be transmitted to a particular network address, e.g., URL, website or the like, to effect control of the data content in accordance with the commands or instructions provided via the user device.

FIG. 4 is an example flowchart illustrating a method for use by a network device, such as for example server 12, for facilitating control of data content being displayed by one device using a second device, in accordance with an embodiment of the present invention.

As shown in block 405 of FIG. 4, the apparatus 20 embodied by the server 12 may be configured to generate a code allowing authorized establishment of a session between a user device and a computing device when the code is displayed by computing device and scanned by the user device terminal. The apparatus embodied by the computing device therefore includes means, such as the processor 22, the communication interface 26 or the like, for generating a code allowing authorized establishment of a session between a mobile terminal and a computing device when the code is displayed by computing device and scanned by the user device. In some embodiments, authorized establishment of a session between a user device and a computing device is allowed when the code is displayed by computing device, scanned by the user device, and provided back to the apparatus.

As shown in block 410 of FIG. 4, the apparatus 20 embodied by the server 12 may be configured to cause transmission of the code to the computing device (i.e. the laptop or the projector configured to display the presentation). The apparatus embodied by the computing device therefore includes means, such as the processor 22, the communication interface 26 or the like, for causing transmission of the code to the computing device.

As shown in block 415 of FIG. 4, the apparatus 20 embodied by the server 12 may be configured to cause establishment of a session in response to the user device scanning the code. The apparatus embodied by the computing device therefore includes means, such as the processor 22, the communication interface 26 or the like, for causing establishment of a session in response to the user device scanning the code. In some embodiments, the apparatus is configured to cause establishment of a session in response to the user device scanning the code and providing the code back to the computing device.

As shown in block 420 of FIG. 4, the apparatus 20 embodied by the server 12 may be configured to transmit data representative of one or more data content available to the mobile terminal for selection. The apparatus embodied by the computing device therefore includes means, such as the processor 22, the communication interface 26 or the like, for transmitting data representative of one or more data content available to the mobile terminal for selection.

As shown in block 425 of FIG. 4, the apparatus 20 embodied by the server 12 may be configured to receive a selection from among the one or more data content that is available from the mobile terminal. The apparatus embodied by the computing device therefore includes means, such as the processor 22, the communication interface 26 or the like, for receiving a selection from the mobile terminal.

As shown in block 430 of FIG. 4, the apparatus 20 embodied by the server 12 may therefore be configured to transmit data content related to the selection to the computing device. The apparatus embodied by the computing device therefore includes means, such as the processor 22, the communication interface 26 or the like, for transmitting data content related to the selection to the computing device.

As shown in block 435 of FIG. 4, the apparatus 20 embodied by the server 12 may be configured to receive an input command related to at least one of a changing of a slide, pointer navigation, highlighting, writing, adding of one or more icons, clearing, or saving. The apparatus embodied by the computing device therefore includes means, such as the processor 22, the communication interface 26 or the like, for receiving an input command related to at least one of a changing of a slide, pointer navigation, highlighting, writing, adding of one or more icons, clearing, and saving. For example, commands or instructions may be related to at least one of a changing of a slide, pointer navigation, highlighting, writing on the screen or in the presentation, adding of one or more icons, clearing the screen, and saving the screen, or the like. For example, the apparatus may be configured such that one or more commands or instructions cause a representation of input provided by the user to be displayed or overlaid upon the display upon the screen

As shown in block 440 of FIG. 4, the apparatus 20 embodied by the server 12 may be configured to transmit data content related to the execution of the command to the computing device (i.e. the laptop or projector configured to display the presentation). The apparatus embodied by the computing device therefore includes means, such as the processor 22, the communication interface 26 or the like, for causing transmission of data content related to the execution of the command to the computing device.

FIG. 5 is an example flowchart illustrating a method for use by a computing device for displaying data content and allowing control of the display of the data content by a different device, in accordance with an embodiment of the present invention. The computing device configured to execute the following process may be embodied by a lap or project configured to display or to cause display of a presentation.

As shown in block 505 of FIG. 5, the apparatus 20 embodied by the computing device 10 may be configured to access a predetermined URL or network address. The apparatus embodied by the computing device therefore includes means, such as the processor 22, the communication interface 26 or the like, for accessing a predetermined URL or network address.

As shown in block 510 of FIG. 5, the apparatus 20 embodied by the computing device 10 may be configured to receive and/or generate a code. The apparatus embodied by the computing device therefore includes means, such as the processor 22, the communication interface 26 or the like, for receiving and/or causing generation of a code. For example, in one embodiment, the apparatus may be configured to receive a QR code from a network device. In another embodiment, the apparatus may be configured to generate the QR code internally using for example, a processor.

As shown in block 515 of FIG. 5, the apparatus 20 embodied by the computing device 10 may be configured to cause display of the code on screen for scanning. The apparatus embodied by the computing device therefore includes means, such as the processor 22, the communication interface 26 or the like, for causing display of the code on screen for scanning.

As shown in block 520 of FIG. 5, the apparatus 20 embodied by the computing device 10 may be configured to access the network site for commands. The apparatus embodied by the computing device therefore includes means, such as the processor 22, the communication interface 26 or the like, for accessing the network site for commands. In some embodiments, the apparatus may be configured to receive the commands directly from a user device. In some embodiments, the apparatus may be configured to access or receive data indicative of one or more commands, where the commands are stored locally.

As shown in block 525 of FIG. 5, the apparatus 20 embodied by the computing device 10 may be configured to cause display of the data content, such as a presentation, and commands. The apparatus embodied by the computing device therefore includes means, such as the processor 22, the communication interface 26 or the like, for causing display of the data content, such as a presentation, and commands. In some embodiments, a user device may provide commands and the computing device may act in response to the commands to alter the display which is presented upon a screen, such as by being projected upon a big screen. Such interaction increases a user's flexibility in controlling the presentation as they walk about the room or as they wish to draw or write upon the touch screen of their user device which in turn is reflected in annotations upon the presentation that is being projected. In some embodiments, audience members may be similarly able to be connected permitting annotations by the audience members to be included in the presentation.

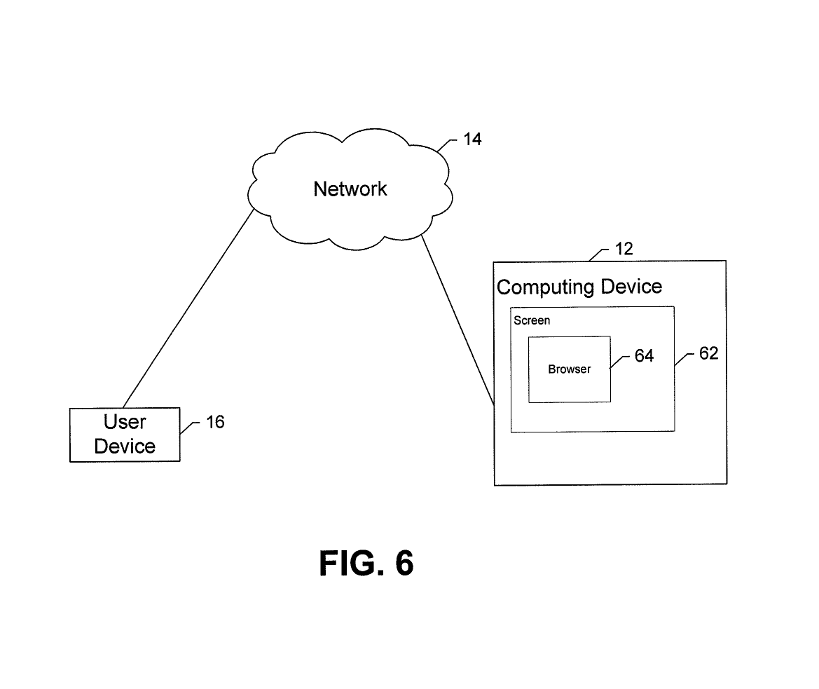

FIG. 6 is a diagram illustrating a system that supports communication between a user device 16, such as a smart phone or a mobile or fixed terminal, and computing device 12, such as a laptop. As shown, the user device 16 and the computing device 12 may be in communication via a network 14, such as for example a cellular network, a local area network, or a wireless local area network. Computing device 12 may include or be associated with a screen 62, such as via a projector, for displaying a presentation or other data content, such as may be provided by a browser 64. The screen may be external, such as a projector screen, and the browser 64 may display a website, HTML5 coded content, or the like. In any event, the method, apparatus and computer program product of an example embodiment permit a user to control the displayed presentation or other data content, such as by permitting annotation of the displayed presentation or other data content.

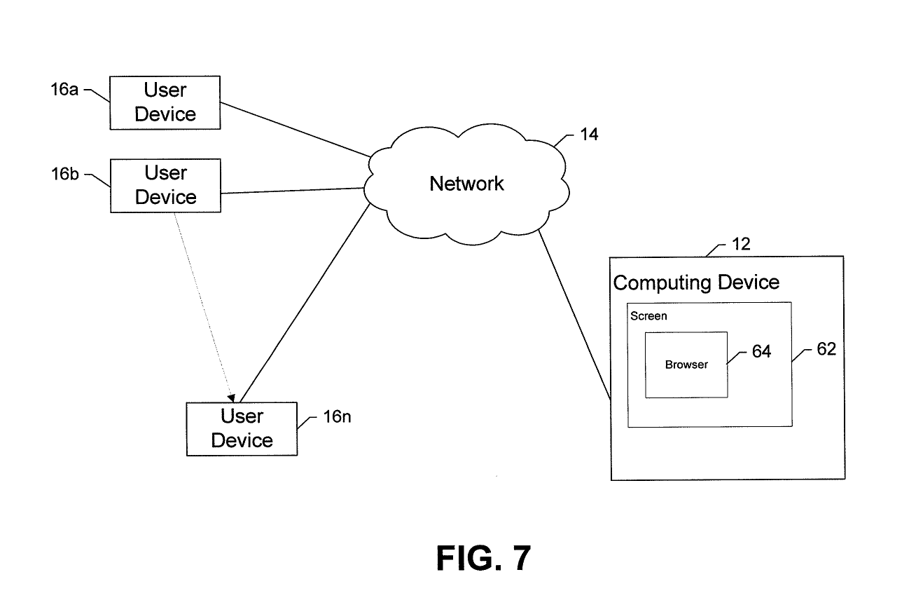

FIG. 7 is a diagram illustrating a system that supports communication between a plurality of user devices 16a, 16b, and 16n, such as a smart phone or other mobile or fixed terminals, and computing device 12, such as a laptop. As shown, the user devices 16a, 16b, and 16n and the computing device 12 may be in communication via a network 14, such as for example a cellular network, a local area network, or a wireless local area network. Computing device 12 may include or be associated with a screen 62, such as via a projector, for displaying a presentation or other data content, such as may be provided by a browser 64. The screen may be external, such as a projector screen, and the browser 64 may display a website, HTML5 coded content, or the like. In any event, the method, apparatus and computer program product of an example embodiment permit a user to control the displayed presentation or other data content, such as by permitting annotation of the displayed presentation or other data content.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
causing, with a processor, authorized establishment of a session;
causing an allowance of an input of at least one of a selection of data content or one or more commands;
receiving the input of at least one of the content selection or the one or more commands; and
causing transmission of the input to a network destination.

2. The method according to claim 1, further comprising:
subsequent to the establishment of the session, causing display of one or more text or icons representative of data content for selection.

3. The method according to claim 1, further comprising:
subsequent to a reception of an input of data content selection and transmission of the input of the content selection, causing display of the data content on a display of a user device.

4. The method according to claim 1, subsequent to a reception of an input of data content selection and transmission of the input of the content selection, receiving an input command related to the content, wherein the command is at least one of a changing of a screen view, pointer navigation, highlighting, writing, adding of one or more icons, clearing or saving.

5. (canceled)

6. The method according to claim 1, wherein causing authorized establishment of a session is performed by scanning a code related to the session.

7. A method comprising:
generating a code allowing authorized establishment of a session between a mobile terminal and a computing device when the code is displayed by computing device and read by mobile terminal;
receiving at least one of a selection of data content and one or more commands; and
causing transmission, in an instance of a selection of data content, of the data content related to the selection, or causing transmission, in an instance of a selection of a command, of the command to the computing device.

8. The method according to claim 7, further comprising:
causing transmission of data representative of one or more data content available to the mobile terminal for selection;
receiving a selection from the mobile terminal; and
causing transmission of data content related to the selection to the computing device.

9. The method according to claim 7, further comprising:
subsequent to transmitting the data content related to the selection to the mobile terminal, receiving an input command, wherein the command is at least one of at least one of a changing of a screen view, pointer navigation, highlighting, writing, adding of one or more icons, clearing, or saving.

10. (canceled)

11. The method according to claim 7, allowing authorized establishment of a session between a mobile terminal and a computing device when the code is displayed by a computing device, read by a mobile terminal, and provided to a network device.

12. An apparatus comprising a processor and a memory having computer code stored therein, the computer code configured, when executed by the processor, to cause the apparatus to:
cause, with a processor, authorized establishment of a session;
cause an allowance of an input of at least one of a selection of data content or one or more commands;
receive the input of at least one of the content selection or the one or more commands; and
cause transmission of the input to a network destination.

13. The apparatus according to claim 12, wherein the computer code is further configured, when executed by the processor, to cause the apparatus to:
subsequent to the establishment of the session, cause display of one or more text or icons representative of data content for selection.

14. The apparatus according to claim 12, wherein the computer code is further configured, when executed by the processor, to cause the apparatus to:
subsequent to a reception of an input of data content selection and transmission of the input of the content selection, cause display of the data content on a display of a user device.

15. The apparatus according to claim 12, wherein the computer code is further configured, when executed by the processor, to cause the apparatus to:
subsequent to a reception of an input of data content selection and transmission of the input of the content selection, receive an input command related to the content, wherein the command is at least one of a changing of a screen view, pointer navigation, highlighting, writing, adding of one or more icons, clearing or saving.

16. (canceled)

17. The apparatus according to claim 12, wherein causing authorized establishment of a session is performed by scanning a code related to the session.

18. An apparatus comprising a processor and a memory having computer code stored therein, the computer code configured, when executed by the processor, to cause the apparatus to:
generate a code allowing authorized establishment of a session between a mobile terminal and a computing device when the code is displayed by computing device and read by mobile terminal;
receive at least one of a selection of data content and one or more commands; and
cause transmission, in an instance of a selection of data content, of the data content related to the selection, or cause transmission, in an instance of a selection of a command, of the command to the computing device.

19. The apparatus according to claim 18, wherein the computer code is further configured, when executed by the processor, to cause the apparatus to:
cause transmission of data representative of one or more data content available to the mobile terminal for selection;
receive a selection from the mobile terminal; and
cause transmission of data content related to the selection to the computing device.

20. The apparatus according to claim 18, wherein the computer code is further configured, when executed by the processor, to cause the apparatus to:
subsequent to transmitting the data content related to the selection to the mobile terminal, receive an input command, wherein the command is at least one of at least one of a changing of a screen view, pointer navigation, highlighting, writing, adding of one or more icons, clearing, or saving.

21. (canceled)

22. The apparatus according to claim 18, wherein the computer code is further configured, when executed by the processor, to cause the apparatus to:
allow authorized establishment of a session between a mobile terminal and a computing device when the code is displayed by a computing device, read by a mobile terminal, and provided to a network device.
